(19) United States
(12) Patent Application Publication
(10) Pub. No.: US 2010/0182134 A1
(43) Pub. Date: Jul. 22, 2010

(54) Navigation Aid

(76) Inventor: Jason Perkins, Wales (GB)

Correspondence Address: GORDON & JACOBSON, P.C., 60 LONG RIDGE ROAD, SUITE 407, STAMFORD, CT, 06902, US

(21) Appl. No.: 12/356,248

(22) Filed: Jan. 20, 2009

(51) Int. Cl. H04B 3/36

(52) U.S. Cl. 340/407.1

(57) ABSTRACT

An apparatus for directing a user to a predefined location, which includes a receiver arranged to receive input information identifying the predefined location as well as an output device for tangibly communicating to the user information for directing the user to the predefined location. Advantageously, the user receives direction information via tactile information transfer means.

### BACKGROUND OF THE INVENTION

1. Field of the Invention

The present invention relates to an aid for navigation, particularly but not exclusively to an aid for navigation of people having impaired visibility.

2. Related Art

Navigation systems are widely available for vehicles where a user inputs a destination by for example audible means and through the use of GPS, the current location of the system and thus the vehicle is identified, and this information is used to compare to a mapping database stored on the system. On the basis of the destination and current location a suitable route is mapped, and instructions on directions to take are provided. Such a system is also available in mobile phone technology, where a mobile telephone comprises a GPS receiver and mapping information.

Partially sighted or blind people presently use a variety of techniques for navigation. Some merely use their senses and rely on educated guesswork and hearing for example. Others use a cane, or alternatively use the assistance of a guide dog. However, visually impaired people often will not venture away from areas they know well due to the anxiety associated with unknown places and finding their way.

### SUMMARY OF THE INVENTION

The present invention aims to provide a system and apparatus for aiding navigation for a visually impaired user.

According to the present invention there is an apparatus for directing a user to a predefined location, the apparatus comprising:
a receiver arranged to receive input information identifying the predefined location;
an output device for tangibly communicating to the user information for directing the user to the predefined location.

An advantage according to the present invention is that the user receives information via a tactile information transfer. Audible directions, whilst suitable for use in a vehicle for example, reduce other senses of a user having impaired sight, meaning their focus is shifted from their surroundings leading to potential dangers and increased anxiety.

The receiver is preferably arranged to receive an audible input. This is beneficial as the user can identify to the receiver the predefined location to which the user wishes to travel The apparatus beneficially also comprises a means for providing an audible output which is beneficially configured to confirm the input received by the receiver in order that the correct predefined location is selected.

An arrangement is preferably provided for determining user directions from a first location to the predefined location. The arrangement preferably includes a processor configured to determine a route between the location of the arrangement and the predetermined location by comparison with a database having map data therein. The apparatus beneficially further comprises a global positioning system receiver which is arranged to receive information relating to the location of the arrangement. Such an apparatus is beneficial as a global positioning system receiver is able to receive accurate information relating to the location of the apparatus and comparison with a database having map data therein enables the detailed route to be calculated between the present location and the predefined location set by the user.

The output device preferably comprises one or more zones arranged to provide a tactile output to a user. The tactile output preferably comprises one or more pulses, the pulses may be sufficiently fast that a user feels a vibration. There are significant benefits associated with such a tactile output as a user is not distracted by an audible instruction. Furthermore, the output is subtle and attention is not drawn towards the visually impaired user.

The output device is preferably shaped and configured to be received in the hand of a user. Additionally, the output device may comprise a clamping arrangement for clamping to an elongate member. The elongate member may be the handle which is attached to the harness for a guide dog. It will be appreciated that the output device may be incorporated in to the handle of the guide dog harness.

The output device preferably comprises a receiving means arranged to receive a signal from the receiver pertaining to user information for directing the user to the predefined location. The receiver may be remote from the output device. This is beneficial as the output device can then be made extremely lightweight as comprises minimal components such that when existing attached or integral with the handle attached to the harness for the guide dog, the weight is low for when the apparatus sits on the guide dog's back when not in use. The receiver beneficially includes a transmitter for transmitting the user information for directing the user to the predefined location to the output device.

Additional objects and advantages of the invention will become apparent to those skilled in the art upon reference to the detailed description taken in conjunction with the provided figures. The present invention will be described by way of example only with reference to the accompanying drawings.

### BRIEF DESCRIPTION OF THE DRAWINGS

FIG. 1a is a schematic perspective view of an input arrangement according to an exemplary embodiment of the present invention.

FIG. 1b is a schematic perspective view of a unit for tangibly communicating information to a user.

FIG. 2a is a schematic perspective view of the arrangement as indicated in FIG. 1a showing the opposing side of the arrangement.

FIG. 2b is a schematic perspective view of the unit as indicated in FIG. 1b showing the opposing side of the unit.

### DETAILED DESCRIPTION

An exemplary embodiment of the present invention has been described with reference to the accompanying drawings where there is schematically represented an arrangement which is most suitable for use by a visually impaired user in conjunction with a guide dog. It would be appreciated, however, that the present invention as defined in the appended claims is not limited in this regard and such a navigation aid may be housed within a single unit and may or may not be used in conjunction with a guide dog. An advantage of the exemplary embodiment of the present invention is that the unit 2 arranged to communicate information via tactile means to the user is of sufficiently light weight that it may be releasably clamped to the guide dog handle such that it may rest on the guide dog's back without causing discomfort. It would be appreciated that this unit 2 may be formed integrally with the guide dog handle in an alternative embodiment. Tactile communication means that there is a physical communication between the device and the user, rather than a solely audible use. Tactile communication may be to any part of a user's body, however it will be appreciated that the arrangement may in many embodiments provide a tangible communication with a user's hand.

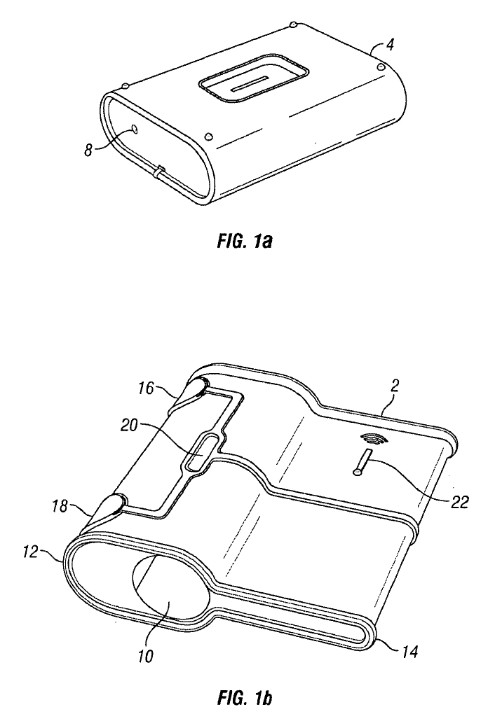

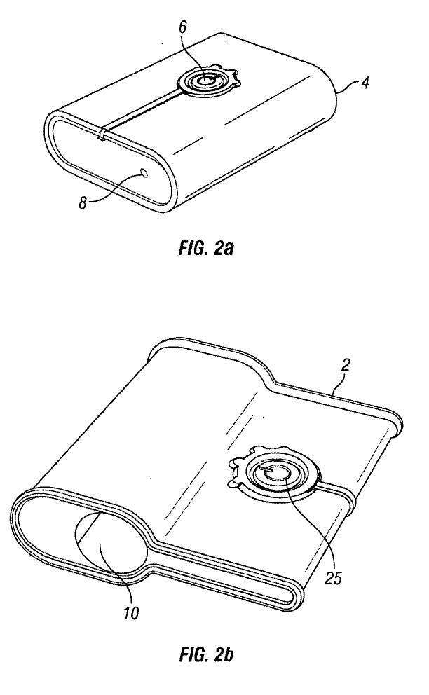

Schematically represented in FIGS. 1a and 2a is an input unit 4 which includes therein a global positioning system receiver which enables the unit 4 to be accurately positioned. A map database is also provided (which can be beneficially stored within the unit or may optionally and alternatively be stored at a remote location) and a processing unit is arranged to determine the position of the unit 4 via the received location information relative to the map information from the map database. A user carrying the unit is therefore able to confirm their present location. An on/off button 6 is provided which when oriented into the “on” configuration may automatically identify the location of the unit and thus the user. The unit 4 also comprises a voice activated input 8 which receives an audible input from the user. For simplicity, once the unit 4 is switched on the unit requests an input provided in an audible format, such as “Where would you like to go?” The voice activated input then receives an input from the user relating to the desired location. This location is then compared with the map database and the most likely result is repeated by the unit 4. If the destination is repeated correctly by the unit 4 then the on/off button 6 is depressed which confirms the chosen destination. The processor located within the unit 4 then determines the optimal route to the desired destination in much the same way as a vehicle satellite navigation system. It will be appreciated that there may be a number of places in a single country having the same name, therefore it is desirable to limit the map database to include information relating to smaller areas such as specific cities or towns which are likely to be to comply with requirements for a visually impaired user. Further information can be downloaded to the unit 4 relating to other cities or areas if necessary. The unit 4 is beneficially shaped to be located within the pocket of a user.

Further user selectable options may be provided with one or more further buttons (not shown) where options are provided wherein the unit may save selected routes (button one). The various saved routes may be availably repeated such that a user can select the desired route by, for example, depressing the button again. Other buttons (e.g. button 2) may be provided which gives the option to “explore and save”, i.e. to save the route taken by the user. A further optional button (button 3) may be provided which gives the user the option to re-trace the route they have just taken.

Referring to FIGS. 1b and 2b, a unit or module 2 is arranged to be mounted onto a handle for a guide dog. A channel 10 is provided which extends through the unit 2 and through which is located the handle bar portion of the arrangement which is mounted via a harness onto a guide dog. The unit 2 is beneficially comprised of two portions which pivot at a first end 12 or a second end 14 of the unit 2. The unit 2 is biased by an arrangement such as a spring (not shown) closed configuration and as such a jaw is provided in an open configuration which may be pushed about the handle (not shown) of the mounting bracket for the guide dog and released thereon. The spring may be of sufficient strength to fixedly clamp the unit 2 onto the handle bar portion, or alternatively a simple clamping mechanism may be provided to prevent relative to rotation between the unit 2 and handle bar portion. It will be appreciated that variety of clamping means may be provided. It will be appreciated that such an arrangement is relatively straight forward for a visually impaired user to mount the handle of the guide dog bracket. It will also be appreciated that in an alternative embodiment the unit 2 may be integrally formed with the guide dog harness and handle.

The unit 2 is arranged such that when in use the user's left hand contacts the underside of the unit which is shown in FIG. 1b. FIG. 2b shows the top of the unit 2. Zones 16, 18, 20 of the unit 2 are provided to correspond to a user's four fingers. The zone 16 is arranged to be in contact with the user's first finger adjacent to the thumb, and zone 18 is arranged to be in contact with the user's smallest finger. Zone 20 is arranged to be in contact with the user's middle two fingers. Configuration as indicated in FIG. 1b is such that the user's middle two fingers generally extend further forwards than the first and smallest finger and as such the zone 20 is positioned further towards the central portion of the unit 2 for a user's comfort such that they do not have to bend their middle two fingers in order to be in contact with zone 20. A user therefore holds onto the unit 2 with their fingers in contact with zones 16, 18 and 20. Vibration may felt by a user through the zones indicating the direction the user should take to reach their predetermined destination as received by the input unit 4. The unit 2 therefore comprises a receiver arranged to receive signals from the unit 4 indicating the direction the user should take. Accordingly, if a user should turn left then zone 18 may vibrate or pulse and if the user should turn right zone 16 may vibrate or pulse. Zone 20 may vibrate or pulse should the user in order to arrive at their destination need to continue in a straight line. Once the user arrives at their destination, simultaneous vibration of all the zones may occur, thereby confirming to the user arrival at the pre-determined destination.

A controller 22 in the unit 2 may be provided to increase or decrease the degree/strength of vibration or pulsing of the zones.

It will be appreciated that the unit 2 must comprise at least one motor and battery which comprises an arrangement to cause pulsing or vibration of the zones. An on/off switch 25 is provided for unit 2.

The embodiment as described above is particularly beneficial for use in conjunction with a guide dog as the guide dog will prevent a user walking into the road for example or prevent a user from succumbing to minor glitches in satellite navigation systems. Furthermore, if, for example, new junctions or buildings have been added before the map database has been updated then a guide dog will prevent the possibility of errors occurring. However, the arrangement will enable a user to explore new areas which cannot be discovered simply by using a guide dog as a guide dogs' learning process is achieved through repetition and training in specific locations.

In an alternative embodiment, the unit 2 may comprise a continuous tactile zone which may comprise variable intensity. The zone may span a portion of the long transverse width of the unit 2 and be of sufficient width such that a user's four fingers can contact the zones. In this embodiment, the zone may vibrate between the extremities of the zone such that if a user is facing the desired destination then the vibration occurs in the zone at a central portion. However, if the user needs to turn left then the degree of turning the user must complete will vary as indicated by the point of the zone which vibrates i.e. if the further most left hand edge of the zone relative to the centre point vibrates then the user must turn around. The user will know once they have turned to a sufficient degree as the zone will vibrate or pulse again in the central portion. Accordingly, the apparatus acts in a similar manner to a compass.

It is envisaged that in an alternative embodiment a unit may be provided which incorporates the features of both unit 2 and unit 4. Such a unit would clearly weigh significantly more than either unit 2 or unit 4 independently and as such may be unsuitable for attachment to the handle bar portion of the harness of a guide dog. However, such a unit may be used independently and may be sufficient for a visual impaired user who does not use a guide dog. The arrangement may function in the same manner however would not need to be shaped and configured to communicate with the handle of the guide dog harness.

In a further alternative embodiment, such an arrangement may be provided within a seat for example, wherein the arrangement for tangibly communicating information to the user may provide a vibration or pulse to a user's back.

In a further embodiment it is envisaged that an arrangement is provided whereby the user inputs their desired destination and the map database is provided at a remote location such that a signal is sent from the input unit to the remote location at which the preferred route is calculated and information relating to directions is continually transmitted to a receiver in the unit 2 and tangibly communicated to the user.

The present invention has been described by way of example only and it would be appreciated by a person skilled in the art that modifications and variations may be made to the present invention without departing from the scope of protection afforded by the appended claims.

What is claimed is:

1. Apparatus for directing a user to a predefined location, the apparatus comprising:
a receiver arranged to receive an input information identifying the predefined location; and
a tactile output device for tangibly communicating to the user information for directing the user to the predefined location.

2. Apparatus according to claim 1 wherein:
the receiver is arranged to receive an audible input.

3. Apparatus according to claim 1, further comprising:
an arrangement for determining user directions from a first location to the pre-defined location.

4. Apparatus according to claim 3, wherein:
the arrangement for determining user directions includes a processor configured to determine a route between the location of the arrangement and the predetermined location by comparison with a database having map data therein.

5. Apparatus according to claim 1, further comprising:
a global positioning system receiver arranged to receive information relating to the location of the apparatus.

6. Apparatus according to claim 1, wherein:
the output device comprises one or more zones arranged to provide a tactile output to a user.

7. Apparatus according to claim 6, wherein:
the tactile output comprises one or more pulses.

8. Apparatus according to claim 1, wherein:
the output device is shaped and configured to be received in the hand of a user.

9. Apparatus according to claim 1, wherein:
the output device comprises a clamping arrangement for clamping to an elongate member.

10. Apparatus according to claim 1, wherein:
the output device comprises a receiving means arranged to receive a signal from the receiver pertaining to user information for directing the user to the predefined location.

11. Apparatus according to claim 1, wherein:
the receiver is remote from the output device.
